(19) United States
(12) Patent Application Publication
(10) Pub. No.: US 2010/0145768 A1
(43) Pub. Date: Jun. 10, 2010

(54) SYSTEM AND METHOD FOR PROJECTING FINANCIALS AND FINANCIAL PROJECTIONS WIZARD

(76) Inventors: Frank Licciardi, New York, NY (US); Christopher Unrath, New York, NY (US); John Newton Pate, New York, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/329,379

(22) Filed: Dec. 5, 2008

(51) Int. Cl. G06Q 10/00; G06Q 50/00

(52) U.S. Cl. 705/10; 705/30; 705/7

(57) ABSTRACT

System and method for projecting financials in the form of a financial projections wizard asks a franchise operator to identify anticipated sales and expenses over a period of years and produces an income statement from the answers provided for subsequent use by potential investors. Various features of the financial projections wizard includes simplified selectable answers, ease-of-use, assessment and identification of discrepancies in the numbers provided, acceptance of user identification of anticipated sales and other projected values in non-annual terms, and a series of questions specifically designed to assist and enable non-financially sophisticated franchise operators in producing a reliable multiple-year income statement.

### BACKGROUND OF THE INVENTION

1. Field of the Invention

The present invention relates to system and method for projecting financials and a financial projections wizard. More particularly, the present invention relates to the creation of an income statement for subsequent use by potential investors in a business, such as a franchise, utilizing an easy-to-use interface to enable franchise operators to enter various financial-related data and other information in response to questions posed.

2. Description of the Related Art

Assessing an investment opportunity is a difficult, time-consuming and expensive process. Among the more important aspects of a business to evaluate is its financial health. This requires the careful examination of company financials—both past and projected. A company's projected income statement will elucidate critical matters such as a business's cost structure, expected profit and growth, and ability to support current pay obligations—as well as monetization/exit opportunities for equity holders of the business.

When the potential acquirer of a business lacks the financial sophistication to develop sound financials, the records become of dubious value and significance—thereby increasing the difficulty, time and overall cost of the due diligence process. This increased cost of evaluating an investment, coupled with the subsequent decrease in absolute return an investor may expect, is one of the more significant reasons private equity investors pursue larger investments rather than smaller ones. As a result, individuals looking to purchase franchised businesses struggle to find private equity.

### OBJECTS AND SUMMARY OF THE INVENTION

In view of the foregoing, an object of the present invention is to provide a way to increase the reliability of financials provided by those who lack financial savvy.

Another object of the present invention is to present an understandable, easy-to-use mechanism to allow operators of franchises and other businesses to provide information that enable for the creation of income statements suitable for analysis by potential investors. Additional objects are further discussed below.

To achieve the foregoing and other objects, the present invention entails, in summary, a financial projections system and a corresponding process for generating an income statement from data provided by an operator of a franchise business, that includes an operator interface (e.g., computer system) for presenting questions to the franchise operator and an income statement generator (e.g., web-based application) that causes the operator interface to present questions that ask the operator for information pertaining to the anticipated performance of the franchise business over a plurality of years and to receive from the operator (via the interface) answers to the questions presented. The income statement generator then generates an income statement that contains financial terms that correspond to the answers provided by the operator.

As an aspect of the present invention, the questions presented include a series of questions that ask the operator to identify the anticipated amount of sales (food-sales and/or non-food sales) during the initial year of operation of the franchise business, to identify the anticipated amount of sales during the first full year of operation of the franchise business, and to identify the anticipated amount of sales during each of the successive four years of operation (or a different number of years) following the first full year.

As a feature of the present invention, the operator is asked to indicate if he/she wants to enter sales data on a non-annual basis (e.g., weekly basis). If so, the entered sales data is converted to yearly amounts by the income statement generator.

As another feature of the present invention, the operator identifies whether the franchise business will generate food sales, non-food sales, or both. Questions are presented for the identified types of sales. If both food and non-food sales are to be generated, then a first set of questions are presented that relate to anticipated amounts of food sales and a second set of questions are presented that relate to anticipated amounts of non-food sales.

As a further feature of the present invention, graphical bars are presented that represent anticipated amounts of sales for the successive years of operation and the operator can modify the amounts by modifying the height of each of the graphical bars.

As another aspect of the present invention, the operator is asked to identify anticipated amounts of the cost of goods sold during the initial year, the first full year and the successive (i.e., subsequent) years of operation of the franchise business.

As an additional aspect of the present invention, the operator is asked to identify the anticipated amounts of employee compensation for the initial year, the first full year and the successive years of operation.

As a feature of this aspect, the operator is presented with a group of selectable answers to identify employee compensation for the successive years. The selectable answers include employee compensation changes with sales, and employee compensation increases at the rate of inflation. Another option that the operator may select is for the operator to enter anticipated monetary amounts of employee compensation during the successive years of operation.

As another feature of this aspect, a first set of questions are presented that relate to compensation of salaried employees (including the operator him/herself and, if applicable, other salaried employees, e.g., a manager) and a second set of questions are presented that relate to compensation of hourly employees. Amounts of salaried employees are requested in dollar terms and amounts of non-salaried (i.e., hourly) employees are requested in terms of percentage of net food sales.

As yet a further aspect of the present invention, questions are presented that relate to occupancy costs during the initial and successive years of operation. Simplified answers of increases at the rate of inflation or no change may be selected for the successive years.

As yet an additional aspect of the present invention, questions are presented that relate to franchise royalties that are to be paid to the franchisor. In particular, the operator is asked to indicate whether the franchise royalties are based only on net food sales or are based on net total sales, and is asked to identify the royalty rate as a percent of sales that must be paid to the franchisor.

As a further aspect of the present invention, questions are presented that relate to anticipated amounts of various operating expenses (e.g., accounting and legal, bank charges and credit card processing) over the initial and successive years of operation. Simplified answers may be selected for the successive years and include the expense(s) changes with sales or the expense(s) increases at the rate of inflation. The operator may request to identify predicted amounts of the expense(s) for such successive years. The operator also may indicate that there will be no change in the expense(s).

As another aspect of the present invention, helpful text is provided, alongside the questions that are presented to the operator, that explains the reason why the question is being asked or how an answer to the question will be utilized.

As yet a further aspect of the present invention, the income statement is generated by including within each field (e.g., row) corresponding to a respective financial term, and which is located in a first section (e.g., column) that corresponds to the initial year of operation of the franchise business, the first value provided by the operator in response to the respective question for such initial year, and by including within each field (row) in the section (column) that corresponds to the first full year of operation the second value supplied by the operator. Fields that correspond to successive years following the first full year are filled with values provided by the operator or are derived (extrapolated) from the first full year value and the operator supplied answer that the value of the successive years changes with sales, increases at the rate of inflation or does not change.

As yet an additional aspect of the present invention, the income statement generator also analyzes the operator's answers to identify any year-to-year fluctuations for specific sales or expenses that are outside a predetermined range (or threshold). Questions are then presented that ask the operator to explain why the operator anticipates those year-to-year fluctuations for such specific sales or expenses. The income statement generator then produces a table that includes the answers provided.

As a feature of this aspect, the generated income statement and the produced table are transmitted to a potential investor of the franchise business.

As yet another aspect of the present invention, the operator is asked to identify the identity of the franchisor, the type of business of the franchise is identified based on the identity of the franchisor, and the series of questions that are presented to the operator is a function of the identified type of franchise business. As a variation, the operator identifies the type of business that, in turn, determines the questions that are presented to the operator.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a basic system block diagram of the present invention;

FIG. 2 is a block diagram of an exemplary computing system that may be employed as the income statement generator of the present invention;

FIG. 3 is a high-level flow chart that identifies various processes that are carried out in accordance with the present invention;

FIG. 4 provides a graphical representation of projected net food sales that may be modified by the operator during a process of the present invention;

FIG. 5 shows an exemplary income statement generated in accordance with the present invention; and

FIG. 6 is an exemplary table that includes answers provided to questions addressing discrepancies in accordance with the present invention.

### DETAILED DESCRIPTION OF THE PRESENT INVENTION

The System and Method for Projecting Financials and Financial Projections Wizard of the present invention provide a way to increase the reliability of financials provided by entities seeking investment capital, particularly entities who lack financial savvy. More particularly, the present invention provides a wizard-like interface to an entity seeking investment capital that walks the entity (called “operator”, “franchisee” or “franchise operator” herein) through a simple series of questions. The questions are exhaustive in that they lead the operator to thoroughly think through all the components that are needed in developing an income statement and, in accordance with the present invention, the questions that are presented are provided in a logical, palatable manner. The responses provided by the operator in turn enable the present invention to build an income statement that is consistent with what potential investors require to effectively and efficiently evaluate an investment opportunity.

As would be appreciated from the following detailed description of System and Method for Projecting Financials and Financial Projections Wizard of the present invention, for convenience simply called herein-after “the Projections Wizard”, the Projections Wizard is particularly optimally suited to be utilized by investors who provide hands-off equity capital to franchise operators (in the form of either debt or equity), as well as to investors of other types of business entities. The Projections Wizard of the present invention beneficially may be employed for any amount of investment range, for example, for investments as low as $50,000 (or even lower) to investments as high as $5 million (or even higher).

Sophisticated investing entities generally require some type of income statement that contains five (5) years of anticipated financials in order to evaluate whether an investment is to be made in a franchise operator or other type of business entity (hereinafter, “franchise operator” or, simply, “operator”). But operators who lack financial savvy generally are unable to produce on their own acceptable income statements. As described further below, the Projections Wizard of the present invention is a rules-based engine that asks the user (i.e., the operator) a series of questions about the anticipated performance of his/her business and develops an income statement utilizing those responses.

In accordance with the present invention, the Projections Wizard asks only those questions that are pertinent to the operator's situation based on how he/she answered prior questions. For example, if the user indicates that there will be additional principals associated with his/her business, the Projections Wizard will ask a series of questions about the compensation allocated to those principals. If the user indicates he/she is the sole owner, then there is no mention of other principals throughout the Projections Wizard. Similarly, if the operator of a restaurant indicates that he/she will have a non-food component to the business (e.g., video games, t-shirts, etc.), then there are a series of questions devoted to capturing the sales and expenses associated with the non-food business. There are various other instances where this logic is employed throughout the Projections Wizard.

In accordance with the present invention, the Projections Wizard also enables the operator with the ability to provide a customized series of financials for every one of the forward-looking five (5) years. As a particularly beneficial feature of the invention, the Projections Wizard extrapolates financials using the first full year of operations as a baseline by enabling the operator with simplified options to identify the basis for such extrapolation (e.g., based on sales, based on expenses). For example, the operator can elect to grow items such as the cost of goods sold or other assorted expenses by inflation, with sales, or manually enter the numbers for each year independently—as well as the option of keeping the expense item flat. As another particularly beneficial feature of the invention, the Projections Wizard provides, if necessary, the operator with a series of questions that relate to areas of prior entries that represent egregious fluctuations in numbers year over year. For example, the operator is prompted to explain why he/she projects a sales increase for a given year of over, for example, 5%. These and other beneficial features of the present invention and their particular manners of operation are described in detail below.

The Projections Wizard: Hardware/Software

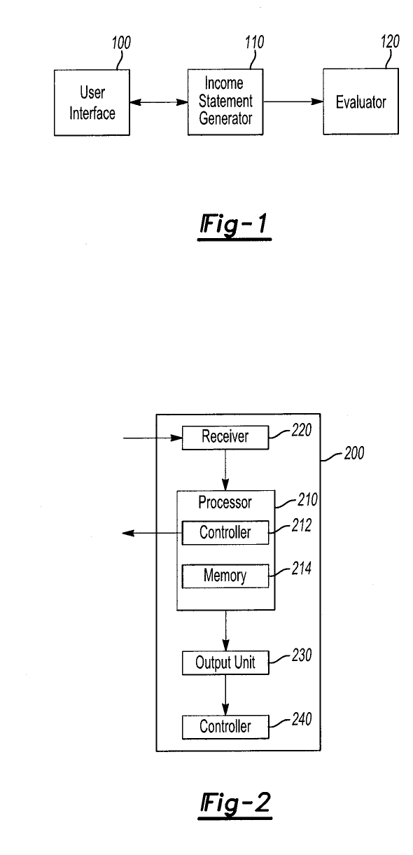

The Projections Wizard of the present invention may be implemented and embodied in various manners. FIG. 1 shows a basic system block diagram in accordance with various embodiments of the present invention. As shown, the system of the present invention includes a user interface 100, an “Income Statement Generator” 110 (or, simply, generator 110), and an evaluator 120. In practice, user interface 100 may be any electronic device, such as a general-purpose computer, that is utilized by the operator as described further below. Generator 110 also is an electronic device, preferably a computer system, that operates to provide the operator (via user interface 100) with a series of questions and receives answers, and then produces an income statement, as herein further described. Evaluator 120 may be another electronic device owned or controlled by a potential investor, or may be the manual evaluation by the potential investor of the income statement that is generated by generator 110.

In one particular implementation of the present invention, user interface 100 is a personal computer that is utilized by, for example, a franchise operator seeking investment and the personal computer communicates with generator 110 via a suitable Internet browser. In another embodiment, user interface 100 and generator 110 are part of the same system, such as a general-purpose computer, wherein software installed on such system is designed to implement the herein-described process. Other system designs may be employed to carry out the various process steps of the present invention. Hence, the system of the present invention may entail one or more electronic devices, such as computers, disposed at one or more locations. For purposes of providing a clear description of the process of the present invention, such process is described in terms of an operator seeking investment using his/her computer (i.e., user interface 100; sometimes referred to the operator's computer) to access a web-based application being performed on a remote computer (i.e., generator 110).

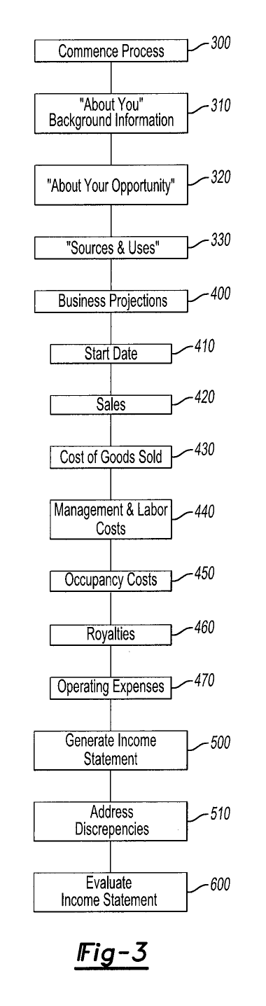

As would be appreciated by those of ordinary skill in the art, generator 110 is executing software designed to carry out the herein-described processes. FIG. 2 shows an exemplary computing system 200 that may be employed as the income statement generator and, as shown, includes a processor 210, a receiver 220, an output unit 230, and a controller 240. Processor 210 includes a controller 212 and memory 214, wherein memory 214 contains software code suitably designed to implement, via controller 212, the processes of the present invention. Since the construction and operation of generator 200 (i.e., generator 110) is well known in the art, further description of the particular hardware elements is not provided herein, except where necessary for an understanding of the present invention. Moreover, given the herein-provided processes of the present invention, as further described below, the application software needed to implement such processes is within the ability to be provided by one of ordinary skill in the relevant art.

The Projections Wizard: Operation

As mentioned above, the Projections Wizard of the present invention is described in terms of a franchise operator accessing a web-based application. In accordance with the present invention, the web-based application presents the operator with a series of questions about the anticipated performance of his/her business and develops an income statement utilizing those responses. As further explained below, various fields of the income statement are populated with values provided by the operator and values of other fields, in particular fields directed to projections beyond the first full year of operation, are extrapolated utilizing projections of the first full year of operation and simplified answers provided by the operator concerning such future years. In certain instances, the Projections Wizard provides select follow-up questions based upon the responses provided by the operator.

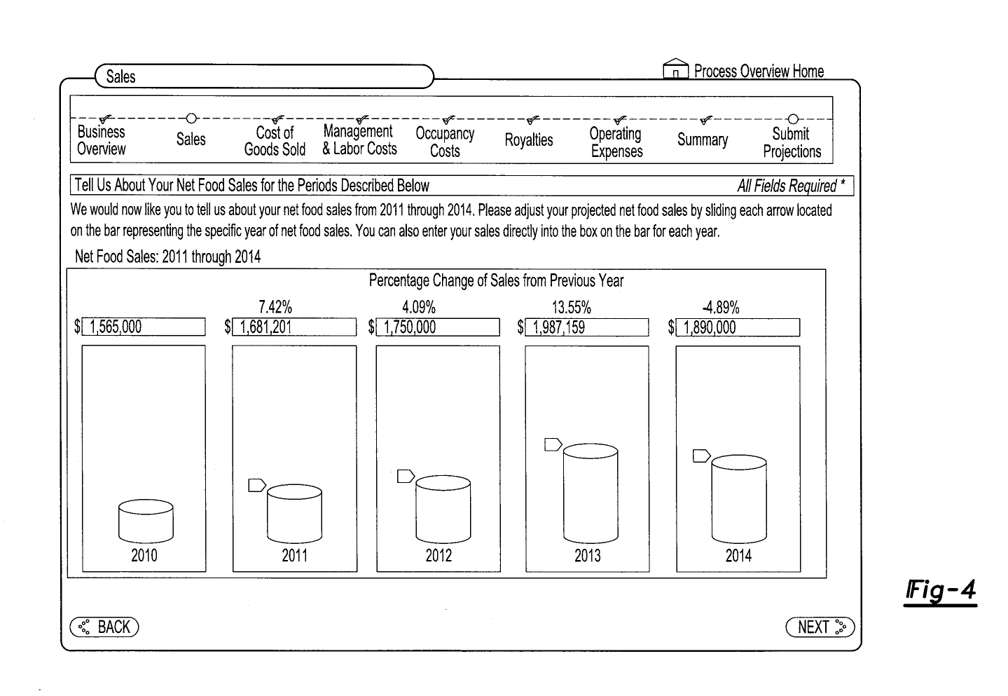

FIG. 3 shows a flow chart that identifies various processes that are carried out in accordance with the present invention. Initially, the operator commences the process of the present invention (step 300), generally by accessing the web-based application that implements the present invention. The web-based application (i.e., the Projections Wizard) organizes the questions to be presented to the operator into the following four general categories (or stages): (1) “About You”; (2) “About Your Opportunity”; (3) “Sources & Uses”; and (4) “Business Projections.” The first three categories pertain mostly to non-projection data, but nevertheless serve to assist the evaluator in its assessment of whether to invest in the franchise operator's business. The final category pertains to projections that are utilized to generate the income statement.

During the first stage “About You,” the Projections Wizard presents the franchise operator with a set of questions that relate to the operator's background as well as financial status and requirements (step 310). Questions asked include the operator's name, contact information, current employment information, spouse's employment information (if applicable), personal financial information including household assets and liabilities and household annual income, and key contacts including contact information for the operator's attorney, accountant, and insurance provider.

During the next stage “About Your Opportunity,” the Projections Wizard presents the franchise operator with a set of questions that relate specifically to the operator's business opportunity, including basic information about the site of the franchise itself, timing, and information about business partners, if any (step 320). Questions asked include location and description of the business, franchisor information, the corporate status of the business (e.g., state of incorporation, federal tax ID, etc.), information about principals or investment partners associated with the business opportunity, including each principal's or investment partner's estimated ownership percentage of the business, and key contacts including contact information for a lender and a franchisor. With particular regard to principals, the Projections Wizard asks the franchise operator to indicate whether there are/will be additional principals with a significant ownership stake in the business (e.g., greater than or equal to 10%). If so, the operator is asked to identify the names of those additional principals, along with such principal's ownership interest in the business.

During the third stage “Sources & Uses,” the Projections Wizard presents the franchise operator with a set of questions that relate specifically to the operator's capital requirements and where the needed funds may come from (step 330). Questions asked that pertain to capital requirements include questions that relate to franchise fees for the current location of the franchise, advanced franchise fees for future business locations, additional franchise fees, the purchase cost of the business unit, capital improvement costs, purchase costs of equipment and inventory, working capital, other business purchases, transactional fees and advisor fees (e.g., accountant, attorney and brokerage fees). Questions asked that pertain to actual and/or potential sources of the funds include questions pertaining to bank loans, personal investments by the operator, investments received from other principals or investment partners, and anticipated tenant improvement rebates.

Business Projections

During the fourth stage “Business Projections,” the Projections Wizard gathers from the franchise operator the information needed to produce a five-year projected income statement for the operator's business (step 400). Prior to presenting questions pertaining to business projections, the Projections Wizard makes it clear to the franchise operator that only the best estimates of the franchise operator are required over the next five years and that the questions that follow are easy-to-follow and straightforward. As a particularly useful and beneficial feature of the Projections Wizard, the operator is provided with an easy to understand explanation for each question that is presented, including an explanation of why the question is presented and how the response will be utilized during assessment of the income statement by the potential investor.

Initially, the Projections Wizard asks the franchise operator to identify the date he/she expects the store or other facility to open (“start date”; step 410). The Projections Wizard uses the identified start date as the starting point of the projections that are presented in the income statement to be generated. The Projections Wizard then presents the franchise operator with questions that relate to the following general categories: (a) Sales; (b) Costs of Goods Sold; (c) Management and Labor Costs; (d) Occupancy Costs; (e) Royalties; and (f) Operating Expenses.

(a) Sales

In accordance with the present invention, the Projections Wizard initially asks the franchise operator as to how he/she would like to project sales (step 420). In particular, the operator is requested to identify whether projected sales that are entered will be (i) on an annual basis or (ii) on a weekly basis. If desired, sales may be projected on another basis (e.g., monthly). If the operator selects a non-annual basis, the Projections Wizard converts all amounts entered into yearly values.

The Projections Wizard next inquires whether the business will generate food-sales, non-food sales, or both. If food sales are to be generated, the Projections Wizard asks the operator to project net food sales for the initial “stub” year beginning with the identified start date of operation through the end of the calendar year (also called herein “initial year” of operation) and to also project net food sales for the following calendar year (also called herein “first full year”). If the amounts entered by the operator represent sales on a non-annual basis then, as mentioned above, the Projections Wizard converts the projections entered into yearly values.

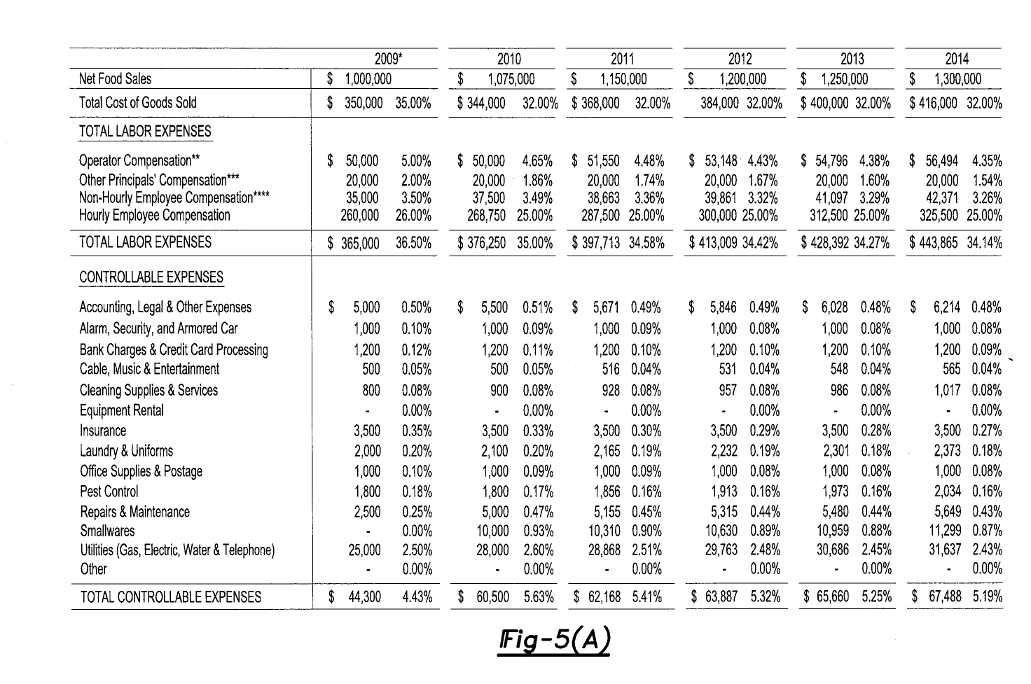

The Projections Wizard next asks the operator to provide projected net food sales for the successive four (4) years that follow the first full year. In accordance with the present invention, the operator may enter values directly or may adjust (e.g., using the computer mouse) any of the 4 bars that graphically represent sales for the successive four years. For example, if the operator identifies a start date of Jul. 1, 2009, then 2009 is the stub year, 2010 is the first full year, and years 2011 through 2014 are the successive four years. In such case, the Projections Wizard provides a graphical representation to the operator as shown in FIG. 4. As shown, a first bar is disposed above “2011,” a second bar is disposed above “2012,” and so on. Preferably each bar is provided in a different color for ease of readability. The height of each bar corresponds to the projected value of a respective year, and the projected value is provided above each bar for such year. In a variation, rather than using the graphical bars shown particularly in FIG. 4, another set of graphical shapes may be displayed to the operator, such as horizontal bars, a pie chart or other suitable graphical representation. Thus, for purposes herein, the term “graphical bar” shall include other graphical representations of the amounts the bars represent.

In addition, the percent change of sales from the previous year also is provided for the second through fourth of the successive years. In accordance with the present invention, to identify or modify a projected value, the operator may manually modify a dollar amount of a particular year or may modify the height of a particular bar using the computer mouse. If the projected value is manually identified, the height of the bar for that particular year is automatically modified to correspond to such manually identified value. Similarly, if the height of a bar is modified, then the projected value (in dollar terms) is automatically modified (i.e., increases or decreases in value) to correspond to the modified height of the bar. Moreover, no matter how the projected value is modified, the percent change of sales from the previous year automatically is modified. As a variation of that described above, the operator also may enter or modify the percentage values that represent the percent change of sales from a previous year. In connection with the present invention's usage of a different type of graphical representation (e.g., a horizontal bar, a pie chart), as mentioned above, a change in shape of such graphical representation by the operator modifies the projected value of a particular year. Hence, for purposes herein, the phrase “modification of the height” or similar phrase (e.g., in the claims below) is intended to broadly mean modification of a shape of the graphical representation of the projected value.

In accordance with the present invention, the above-described manner in which the franchise operator identifies projected net food sales beneficially provides the operator with information, in both numerical and graphical form, that assists the operator to determine, if applicable, whether the projected values are unrealistic or overly conservative. Accordingly, the present invention provides the operator with the added benefit and ability of modifying, if desired, projected values based on the numerical and graphical feedback of the Projections Wizard.

If the operator previously identified that the business will generate non-food sales, then the Projections Wizard asks the operator to project net non-food sales in the same manner that projected net food sales are requested, as previously described. That is, the Projections Wizard asks the operator to project non-food sales for the initial stub and for the first full year, and then asks the operator to project non-food sales for the successive four years utilizing bar graphs similar to those shown in FIG. 4. Like with food sales, if the operator previously indicated that he/she will provide sales projections on a non-annual basis (e.g., weekly), the Projections Wizard converts all entered projected non-food sales into annual amounts.

(b) Costs of Goods Sold

The Projections Wizard next asks the franchise operator to provide projections that relate to the cost of goods sold (FIG. 3; step 430). If the operator previously identified that the business will generate food sales, then the Projections Wizard asks the operator to project costs that relate to food products, in particular, the food and paper costs of the business. Similarly, if the operator previously identified that the business will generate non-food sales, then the Projections Wizard asks the operator to project costs that relate to non-food products (e.g., mugs, T-shirts, etc.). Advantageously, to aid the operator in his/her projections, the operator may enter projected costs of goods sold as a percentage of net food sales or net non-food sales, whichever is applicable.

In accordance with the present invention, the Projections Wizard provides the operator with a simplified task of entering the costs of goods sold by requesting the following: (a) a projection of the costs of goods sold for the stub year as a percentage of sales (food or non-food, whichever is applicable) during that stub year; (b) a projection of the costs of goods sold for the first full year as a percentage of sales (food or non-food) during that first full year; and (c) an indication of whether the costs of good sold for each of the four successive years will be the same percentage of sales as they will be for the first full year. If the operator responds to inquiry (c) in the negative, then the Projections Wizard prompts the operator to manually identify the anticipated costs of goods sold for each of the successive four years as a percentage of sales during the respective year.

(c) Management & Labor Costs

The Projections Wizard next asks the franchise operator to provide projections that relate to management and labor costs (step 440). In particular, questions asked relate to the franchise operator's compensation, compensation of other salaried employees, if any, and compensation of hourly employees. More specifically, the Projections Wizard asks the operator to identify his/her own base salary including associated costs to the business for taxes and benefits (but excluding performance pay or dividends) in the stub year and in the first full year, and to identify how his/her own base salary is expected to grow for the successive four years relative to the base salary in the first full year.

As a particularly useful feature, the Projections Wizard allows the operator to select one of following four responses in reply to how his/her own base salary is expected to grow for the successive four years: (a) “Change with Sales”; (b) “Grow with Inflation”; (c) “No Change”; and (d) “None of the Above.” The Projections Wizard instructs the operator to select option (a) if the operator's base salary is expected to increase or decrease by the same percentage as sales, to select option (b) if the operator's base salary is expected to grow at the same rate as inflation, which is identified as having averaged 3.1% over the last 25 years, and to select option (c) if the operator expects his/her base salary to remain the same. Finally, the Projections Wizard instructs the operator to select option (d)—“None of the Above”—if the operator wants to manually enter his/her anticipated base salary for each of the four successive years. If the operator chooses option (d), then the Projections Wizard requests the operator to identify his/her anticipated salary in each of the four successive years.

The Projections Wizard next asks the operator if he/she plans to pay himself/herself additional compensation other than the base salary that was already entered. The Projections Wizard instructs the operator that such additional compensation might include dividends, commissions, management fees, consulting fees or bonuses. If the operator responds in the affirmative, the Projections Wizard prompts the operator to estimate what that additional compensation will be in a typical year and to identify how that amount is determined.

The Projections Wizard next asks the operator to identify the base salary of each additional principal of the business that the operator identified during the stage “About Your Opportunity,” previously discussed. Like the questions presented concerning the operator's own salary, the anticipated salary of each additional principal in the stub year, the first full year, and the successive four years are requested. The above-identified four replies also are presented in connection with the base salary during the successive four years. Then, the Projections Wizard asks the operator if there is plan to pay the other principals additional compensation (other than the base salary that was already entered) and, if so, the operator is prompted to identify the estimated amount and how that amount is derived.

The Projections Wizard next asks the operator if the business will have other employees who will receive an annual salary, such as a store manager. If the operator responds in the affirmative, then the Projections Wizard asks the operator the same questions that were previously asked about the operator's own compensation (and the other principals' compensation, if any). As a beneficial feature that simplifies the operator's inputs and estimates, the Projections Wizard requests that the operator project the combined base salary of all other salaried employees for the stub year, the first full year and the four successive years. The above-identified four options are provided in connection with the operator's projection of the combined base salary in the four successive years. If additional compensation is to be paid to any other salaried employee, the operator is prompted to estimate the amount of additional compensation in a typical year and to identify how that amount is determined.

The Projections Wizard next asks the operator to identify hourly-employee expense by requesting the following: (a) the total hourly-employee expense (including the associated costs to the business for taxes and benefits) as a percentage of net food sales for the stub year; (b) the total hourly-employee expense (including associated costs) as a percentage of net food sales for the first full year; and (c) an indication as to whether the hourly-employee expenses for the successive four years will be the same percentage of food sales as they will be for the first full year.

As with other questions presented, the Projections Wizard beneficially provides an explanation that may be useful to the operator in assessing future hourly labor cost. In particular, the Projections Wizard provides the following information alongside inquiries (a), (b) and (c) provided above: “Many operators believe their hourly labor costs as a percent of net food sales will remain constant throughout the foreseeable future. If you believe this to be the case for your business, please select ‘Yes’ and we can move on to the next topic. Other operators, however, believe that increasing efficiencies may lower hourly labor costs, whereas others believe inflationary pressure or tightening labor markets may cause their hourly labor costs to increase as a percent of net food sales. If you believe your labor costs as a percent of net food sales will change from year-to-year, select ‘No’ and you'll have the opportunity to enter a specific estimate for each year from 2011 through 2014.” If the operator responds to inquiry (c) in the negative, then the Projections Wizard prompts the operator to project the total hourly-employee expense as a percentage of net food sales for each of the successive four years.

(d) Occupancy Costs

The Projections Wizard next asks the franchise operator if the location he/she will be operating from will be a leased location or will the business own the location from which it operates (step 450). The operator may also indicate that he/she currently does not know if the location is to be leased or owned. If the operator responds that the location is an owned location or does not know yet, then no further questions concerning occupancy costs are presented. If, however, the operator responds that the location is to be leased, then the Projections Wizard requests the following: (a) the amount of rent expense, including any landlord revenue participation payments, all common area charges and taxes, for the stub year; (b) the amount of rent expense, including any landlord revenue participation payments, all common area charges and taxes, for the first full year; and (c) and how the rent expense will change for the successive four years. The Projections Wizard provides, alongside inquiries (a), (b) and (c) stated above, the useful following explanation of why the question is being asked: “Leases differ from Landlord to Landlord and state-to-state. We're trying to understand what the total costs of occupancy for your business will be as required by the terms of your lease. This would include, for instance, real estate taxes and maintenance payments. It also may include some form of variable payment made to the Landlord to provide them with a share of the revenue of your business. Other overhead associated with your lease such as utilities and insurance will be captured shortly.”

Similar to various prior questions posed, the Projections Wizard beneficially allows the operator to easily select one of the three following responses in reply to how the rent expense will change for the successive four years: (a) “Change with Inflation” (b) “No Change”; and (c) “None of the Above.” If the operator selects option (c), the Projections Wizard allows the operator to manually identify the rent expense in each of the four successive years.

(e) Royalties

The Projections Wizard next asks the franchise operator to identify whether his/her franchise royalty will be based only on net food sales or will be based on net total sales (food sales and non-food sales combined), and to identify the royalty rate, as a percent of net food sales or total sales, whichever is applicable, that he/she is required to pay the franchiser (step 460).

(f) Operating Expenses

The Projections Wizard next asks the franchise operator to provide projections relating to operating expenses that are associated with running the operator's business (step 470). Questions asked pertain to the following categories: (1) Accounting, Legal & Other Advisors; (2) Alarm, Security, and Armored Car; (3) Bank Charges & Credit Card Processing; (4) Cable, Music & Entertainment; (5) Cleaning Supplies & Services; (6) Equipment Rental; (7) Insurance; (8) Laundry & Uniforms; (9) Licenses & Permits; (10) Marketing Fee Required and Collected by Franchisor; (11) Marketing Controlled by Operator; (12) Office Supplies & Postage; (13) Pest Control; (14) Repairs & Maintenance; (15) Smallwares; (16) Utilities (Gas, Electric, Water, and Telephone); and (17) Other.

For each of the above-listed operating expense categories, the Projections Wizard asks the operator to identify: (a) the anticipated cost in the stub year; (b) the anticipated cost in the first full year; and (c) the anticipated cost in each of the four successive years. In connection with the anticipated costs in each of the four successive years, the Projections Wizard beneficially allows the operator to easily select one of three responses: (a) “Change with Sales” where the expense is expected to increase or decrease by the same percentage as sales; (b) “Grow with Inflation” where the expense is expected to grow at the same rate as inflation; or (c) “No Change” wherein the expense is expected to remain constant. In a variation, the fourth option (d) “None of the Above” may be selected by the operator, in which case the operator is prompted to manually identify the anticipated expense in each of the four successive years.

The Projections Wizard also provides useful information and guidance to the operator alongside the questions presented for each of the operating expense categories. For example, when the Projections Wizard requests the operator to identify costs associated with accounting, legal and other advisors, the Projections Wizard provides the following useful instructions: “These are fees you pay to accountants, lawyers, advisors and consultants, including any fees you pay to accountants for ordinary work such as filing taxes or bookkeeping should be tracked here. However, fees paid to accountants for unusual work, such as advising you on how to acquire a business, should not be forecasted here. Any fees you pay to lawyers in the ordinary course of business, but excluding the costs for extraordinary transactions such as the financing you are seeking now, should be included here. Any fees you pay to other professional advisors to help you with the management of your business.”

As another example, when the Projections Wizard requests the operator to identify costs associated with bank charges & credit card processing, the Projections Wizard provides the following useful instructions: “These are fees you pay to banks and credit card companies, including: Fees you pay to your bank such as per check service fees, monthly account maintenance fees, and fees charged for having the bank send a wire. Bank charges should NOT include interest you pay to the bank for borrowing money or arranging a loan to capitalize your business. Fees paid to allow you to process and collect credit card payments. These exclude any equipment and cable costs required for processing credit cards; those equipment charges should be considered capital expenditures.”

Generation of Income Statement

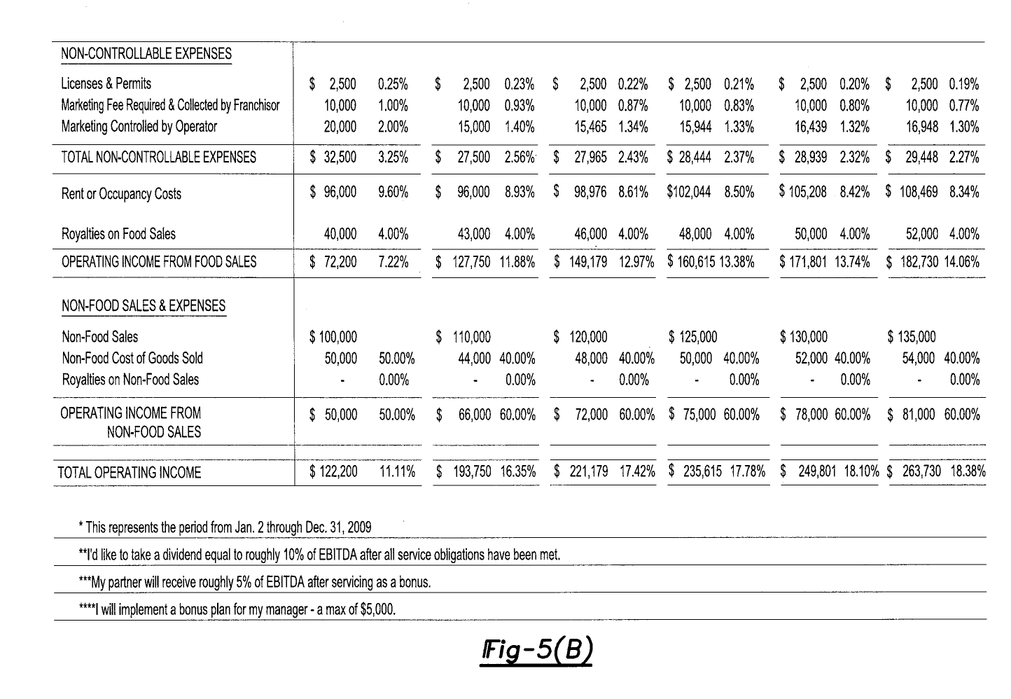

In accordance with the present invention, the Financials Wizard generates from the information provided by the franchise operator a completed income statement (step 500). FIG. 5 shows an exemplary income statement generated in accordance with the present invention. As shown, the left-hand column includes the line items “Net Food Sales,” “Total Cost of Goods Sold,” “Operator Compensation,” “Other Principal's Compensation,” and so on. In the exemplary income statement, the stub year is 2009. As already described, the Projections Wizard asked the operator to identify the anticipated value of each line item for the stub year and also for the first full year (2010 in FIG. 5). The Projections Wizard also asked the operator to identify, in various manners, the projected amounts of such items for the four successive years. The Projections Wizard in turn enters the values provided in the appropriate column (also called “field” herein) of the income statement being generated. In cases where the operator did not manually provide specific amounts for the successive years, the Projections Wizard computes each of the values to be included in the successive year columns (2011 through 2014) as a function of the first full year value and the answer selected (e.g., “Change with Sales,” “Grow with Inflation,” “No Change,” etc.).

The Projections Wizard also computes amount totals for each expense category (e.g., total labor expense) and for income, and includes the totals computed in the income statement. In addition, the Projections Wizard also includes in the income statement amounts provided or calculated in percent terms (e.g., amount of operator compensation as a percentage of net food sales) and, where necessary, computes dollar amounts for items that were provided by the operator in percent terms (e.g., hourly employee compensation). Since the mathematical computation of the various numbers derived by the Projections Wizard as herein described are within the ability of one of ordinary skill in the art, specific mathematical formulas are not provided herein.

The Projections Wizard further includes one or more footnotes to the income statement to provide additional useful information, including at least the period represented by the stub year. For example, and as shown in FIG. 5, the first footnote “* This represents the period from Jan. 2 through Dec. 31, 2009” clearly identifies that the period of the initial year. Subsequent footnotes contain the description previously provided by the operator about the additional compensation, if any, that is to be paid to the operator, other principals/business partners, salaried employees and/or hourly employees. For example, the income statement shown in FIG. 5 includes three additional footnotes that describe the additional compensation of the operator, the operator's partner and the manager.

The Projections Wizard presents the generated income statement to the operator and asks the operator to review the information included in the income statement to verify that the information is accurate and reflects the operator's best prediction of the future performance of his/her business. The Projections Wizard also indicates to the operator that prior values may be modified. The operator is afforded the ability to access prior questions in various manners, including allowing the operator to click the “Back” button (i.e., to go to a prior screen) or to click on the relevant section using a progress bar that is displayed at the top of the screen (e.g., see FIG. 4) or at another suitable viewable location. Other manners of modifying previously entered information also may be employed within the Projections Wizard of the present invention. The Projections Wizard also provides the operator with the ability to print or export (e.g., to a spreadsheet computer file) the generated income statement.

Projections Wizard Analysis of Data . . . Discrepancies

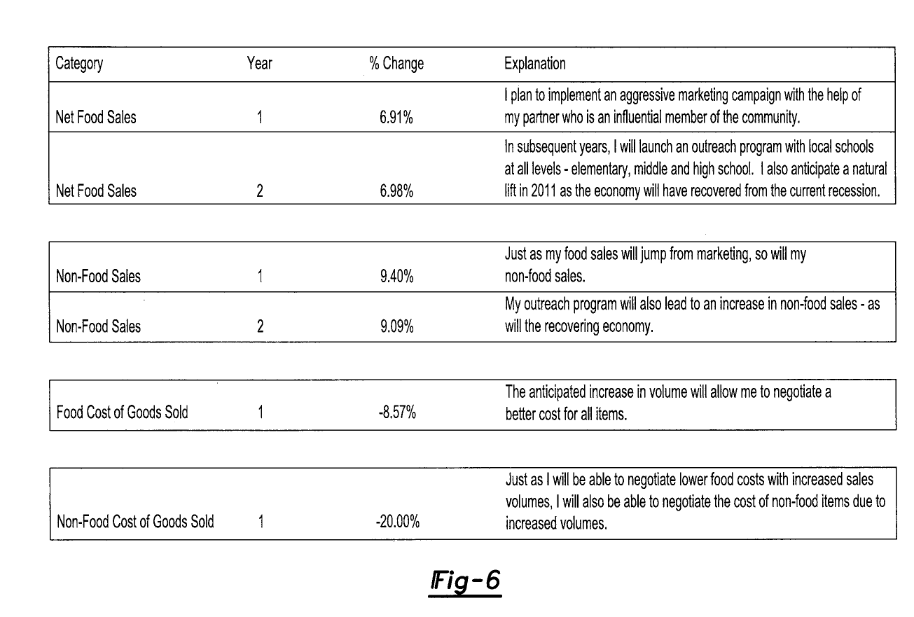

As a particularly beneficial feature of the present invention, after completion of data entry by the franchise operator, the Projections Wizard analyzes the information provided by the franchise operator, identifies year-to-year fluctuations that are outside predefined thresholds (or a predetermined range), that is, that represent egregious fluctuations in numbers year over year, and prompts the operator with a series of questions that seeks to clarify such egregious fluctuations (“Address Discrepancies”; step 510). For example, the operator is requested to explain why he/she projects a sales increase of over 5% for any given year. As another example, the operator is requested to explain why he/she projects a labor cost decrease that is greater than 3% (or another percentage). During this line of questioning, the Projections Wizard informs the operator that his/her answers will help potential investors with a better understanding of his/her business and will speed up the process of providing the operator with a financing proposal. A table that includes the operator's answers to the questions presented, if any, accompanies the generated income statement when it is printed, exported or, as further discussed below, transmitted to a potential investor for evaluation. FIG. 6 illustrates an exemplary table that may be generated by the Projections Wizard that incorporates answers provided by the operator during this line of questioning. As shown, the table identifies, for each question presented, the category to which the question pertains, the applicable year of the projected value, the percent change from the prior year, and the explanation provided by the operator.

Evaluation by Potential Investor

In accordance with the present invention, the Projections Wizard transmits the generated income statement, along with operator responses to questions addressing discrepancies, to a bank or other types of potential investors of the operator's business. Transmission may occur directly to the potential investor (evaluator 120; FIG. 1) from the system (income statement generator 110) implementing the Projections Wizard. Transmission also may occur indirectly, such as where the franchise operator simply provides printed copies (or electronic copies) of the generated income statement to one or more potential investors. In turn, the potential investor evaluates the generated income statement to determine whether the operator's business is appropriate to be invested in. The potential investor further evaluates the operator responses that address all discrepancies as set forth in the table that accompanies the income statement. As would be appreciated, the generated income statement and accompanying table beneficially enable a potential investor to ascertain whether an investment is to be made in the operator's franchise.

In one implementation of the present invention, the Financials Wizard of the present invention is controlled by an investment entity whereby the generated income statement is immediately evaluated by that investment entity. Hence, in such implementation, income statement generator 110 and evaluator 120 in FIG. 1 represent the same entity.

Benefits

As previously discussed, the Projections Wizard of the present invention provides an easy-to-use interface and question/answer format, along with simplified answer options, to enable entities who seek investment capital to easily generate a five year income statement. The Projections Wizard also operates in a manner and generates an income statement that increases the reliability of financial data that is provided by franchise operators and operators of other types of businesses.

The Projections Wizard of the present invention beneficially is easy to access, via a website or other web-type application format, and is paperless, thus enabling business operators with the ability to produce an income statement, for the most part, anywhere and without the need to employ costly financial advisors.

The Projections Wizard beneficially provides a consistent technique/procedure for generating income statements, thus enabling an individual investment entity with the luxury of receiving, reviewing and comparing like-form/substance income statements of different businesses in its assessment of which business or businesses to invest in.

The Projections Wizard beneficially provides help text specifically designed to assist the operator in properly answering (including properly projecting) each question presented.

The Projections Wizard beneficially allows operators to quickly and easily select simplified answers to questions pertaining to projections for the successive years of operation of the business. Questions pertaining to different types of costs/sales include simplified answers tailored to such different types of costs/sales, thus further enabling the operator to identify future projections in a quick, simplified and appropriate manner. The selectable answers provided for various questions particularly are beneficial to less sophisticated business owners who may not otherwise be able to estimate future values without the aid of expensive consultants. In addition, the Projections Wizard graphical representation of sales for each of the successive years similarly provides a useful tool to assist operators in estimating future sales.

The Projections Wizard further beneficially allows business operators with the ability of entering certain data in non-annual terms, thus further facilitating correct entry of information at least by those who tend to understand sales (or even costs) in non-annual (e.g., weekly, monthly) amounts.

Projections Wizard: Variations

The Projections Wizard has been described in specific terms as presented above. However, the present invention is not limited solely to such specific description and may be modified in various manners as further discussed below.

As would be appreciated, different types of devices and systems may be designed (via hardware and/or software) to implement the processes as herein described. The present invention may be embodied solely within software (e.g., contained on a computer-readable medium) that, when executed on a computer, carries out the processes of the present invention. Since the particular software needed to implement the present invention as described herein is, given the detailed description herein, within the ability of one of ordinary skill in the art, particular software code is not presented herein. Also, the term “computer” incorporates other devices (e.g. PDA, interactive television) that can be designed and/or programmed to implement the present invention. Further, the manner in which the operator enters information may be carried out in different manners, including via a keyboard, a mouse, a number pad, orally, or using other suitable technique or device. Still further, the manner in which the Projections Wizard of the present invention presents questions to the operator may be carried out in various manners, including via a computer or other electronic display (e.g., on a smart phone, a PDA, etc.), orally, or other technique. And the manner of communication between the operator's interface (i.e., user interface 100) and the Projections Wizard (i.e., income statement generator 110) may be direct or indirect via the Internet, via a private network, via telephone or other suitable form of communication.

The questions presented to the operator by the Projections Wizard of the present invention may be modified in various ways from that described above. In one variation, the order of the questions presented is changed. For example, questions relating to non-controllable expenses are presented prior to questions relating to controllable expenses. As another example, questions relating to expenses precede questions relating to sales. Other ordering modifications are possible. In another variation, questions pertaining to various expenses or sales are broken out into multiple sets of questions. For example, insurance costs may be broken out into multiple sets of questions with a first set of questions pertaining to, for example, liability insurance, another set of questions pertaining to, for example, theft, fire, flood, etc. insurance and, a third set of questions pertaining to, for example, employee health insurance (which is included in employee compensation as described above).

In a further variation, questions presented can be grouped together or broken out further based upon the type of business of the operator. For example, different types of businesses, such as restaurants with table services, take-out only food businesses, phone-order only businesses, non-food facilities, mail-order only non-food entities, etc., sometimes have different types of expenses and, thus, the present invention may present questions that are more finely tailored to the particular business under consideration. More particularly, in one version, the Projections Wizard of the present invention identifies the type of business of the operator based on the identity of the franchisor and presents a set of questions based on the identified industry. In other words, the type of industry of the franchiser is ascertained and the particular track the operator travels down (i.e., the questions and selectable answers that are presented) is a function of the type of industry ascertained. For example, in the exemplary income statement presented in FIG. 5, it is shown that a Baskin Robbins franchise is to open. In accordance with this particular version of the present invention, the Projections Wizard would identify the franchise as a food industry type business (e.g., using a look-up table) and then present questions (and selectable answers) pertinent to the food industry in order to ascertain all of the data necessary to generate an income statement, as herein described. If the Projections Wizard identifies that the business is in a different type of industry (e.g., hospitality, education services, etc.), then the operator is taken on a different track. That is, a different set of questions (and possibly selectable answers) is presented. As another variation, rather than the Projections Wizard identifying the type of business based on the identity of the franchisor, the operator may be asked to identify the type of business (e.g., from a list of types provided). Hence, the present invention, in these particular versions, beneficially tailors the questions presented to the operator's specific industry of interest.

In other variations, the answers that are presented to the operator for selection may be modified in various ways from that described above. In one version, the operator is able to enter answers either in dollar amounts or as a percentage of another number in response to select questions (e.g., marketing costs may be entered as a percentage of sales; rent can be entered in different terms if it isn't a flat number, etc.). In another version, the operator is provided the opportunity to enter various expenses on a non-annual basis (e.g., monthly basis). In the description above, the operator may choose to enter anticipated sales on, for example, a weekly basis, and this feature may be extended to non-sales projections. In a further version, the operator is provided with yet additional answers that can be selected. For example, for select questions, it may be beneficial to allow the operator to select a response that indicates that the particular expense follows sales, but at a specified rate (e.g., 50% rate of sales). Other variations of answers may be employed where useful.

The income statement that is generated by the Projections Wizard of the present invention may be modified in various ways from that described above. In one variation, the income statement includes a different number of years of projection. For example, the Projections Wizard can generate a 7-year income statement with the information provided. In another variation, the format (e.g., arrangement of the line items) of the income statement may be different.

Finally, various quoted terms and phrases have been provided herein, such as “Change with Sales,” “Grow with Inflation,” “No Change,” “None of the Above,” etc. Other suitable terms and phrases that convey the same meaning may be employed in place of those phrases used herein.

The present invention and multiple variations thereof have been described. It is to be understood, however, that other expedients known to those skilled in the art or disclosed herein may be employed without departing from the spirit of the invention.

What is claimed is:

1. A financial projections system, comprising:
an operator interface for presenting information to an operator of a franchise business and for receiving from the operator input data; and
an income statement generator in communication with the operator interface and adapted to control the operator interface to present a plurality of questions related to an anticipated performance of the franchise business over a plurality of years and to receive from the operator answers to each of the presented questions; the income statement generator generating an income statement containing financial terms corresponding to the operator answers to the presented questions.

2. The financial projections system of claim 1, wherein the plurality of questions presented by the operator interface includes a series of questions that ask the operator to identify an anticipated amount of sales during an initial year of operation of the franchise business, to identify an anticipated amount of sales during a first full year of operation of the franchise business, and to identify an anticipated amount of sales during each of a plurality of successive years of operation following the first full year.

3. The financial projections system of claim 2, wherein the income statement generator controls the operator interface to request the operator to identify a preferred time period basis in which to provide answers to questions relating to anticipated amounts of sales, the preferred time period basis being one of an annual basis and a non-annual basis; and the income statement generator converts into yearly amounts values provided by the operator relating to anticipated amounts of sales if the operator identified a preferred time period basis corresponding to a non-annual basis.

4. The financial projections system of claim 2, wherein the income statement generator controls the operator interface to request the operator to identify whether the franchise business will generate food sales, non-food sales, or both food and non-food sales; and the series of questions relating to anticipated amounts of sales relates to the type of sales to be generated by the franchise business as identified by the operator; the series of questions relating to anticipated amounts of sales including, if the operator identified both food and non-food sales, a first set of questions relating to anticipated amounts of food sales and a separate, second set of questions relating to anticipated amounts of non-food sales.

5. The financial projections system of claim 2, wherein the income statement generator controls the operator interface to display to the operator, along with the question that asks the operator to identify an anticipated amount of sales during each of the plurality of successive years of operation, a plurality of graphical bars that represent the anticipated amount of sales during the successive years of operation, and the income statement generator controls the operator interface to enable modification of a height of any one or more of the displayed graphical bars, the height of each of the graphical bars representing a value of the anticipated amount of sales during a respective one of the successive years of operation.

6. The financial projections system of claim 1, wherein the plurality of questions presented by the operator interface includes a series of questions that ask the operator to identify an anticipated amount of cost of goods sold during an initial year of operation of the franchise business, to identify an anticipated amount of cost of goods sold during a first full year of operation of the franchise business, and to identify an anticipated amount of cost of goods sold during each of a plurality of successive years of operation following the first full year.

7. The financial projections system of claim 1, wherein the plurality of questions presented by the operator interface includes a series of questions that ask the operator to identify an anticipated amount of employee compensation during an initial year of operation of the franchise business, to identify an anticipated amount of employee compensation during a first full year of operation of the franchise business, and to identify an anticipated amount of employee compensation during each of a plurality of successive years of operation following the first full year.

8. The financial projections system of claim 7, wherein the question that asks the operator to identify the anticipated amount of employee compensation during each of the plurality of successive years of operation includes a plurality of answers selectable by the operator, the plurality of selectable answers including at least a first answer corresponding to the employee compensation changes with changes in sales of the franchise business, and a second answer corresponding to the employee compensation increases at a rate of inflation.

9. The financial projections system of claim 8, wherein the plurality of selectable answers includes at least a third answer corresponding to a request by the operator to identify monetary values of the anticipated amount of the employee compensation during each of the plurality of successive years of operation.

10. The financial projections system of claim 7, wherein the series of questions includes a first series of questions relating to anticipated amounts of compensation of salaried employees during multiple years of operation of the business and a second series of questions relating to anticipated amounts of compensation of hourly employees during said multiple years of operation.

11. The financial projections system of claim 10, wherein the first series of questions request answers in terms of dollar amounts and the second series of questions request answers in terms of percentage of net food sales.

12. The financial projections system of claim 1, wherein the plurality of questions presented by the operator interface includes a series of questions that ask the operator to identify an anticipated amount of occupancy costs during an initial year of operation of the franchise business, to identify an anticipated amount of the occupancy costs during a first full year of operation of the franchise business, and to identify an anticipated amount of the occupancy costs during each of a plurality of successive years of operation following the first full year.

13. The financial projections system of claim 12, wherein the question that asks the operator to identify the anticipated amount of the occupancy costs during each of the plurality of successive years of operation includes a plurality of answers selectable by the operator, the plurality of selectable answers including at least a first answer corresponding to the operating expense increases at a rate of inflation, and a second answer corresponding to no change in an amount of the occupancy costs during each of the plurality of successive years of operation.

14. The financial projections system of claim 1, wherein the plurality of questions presented by the operator interface includes a series of questions relating to franchise royalties to be paid to a franchisor of the franchise business.

15. The financial projections system of claim 14, wherein the series of questions includes a first question that asks the operator to indicate whether the franchise royalties are based only on net food sales or are based on net total sales, and a second question that asks the operator to identify a royalty rate as a percent of sales that must be paid to the franchisor.

16. The financial projections system of claim 1, wherein the plurality of questions presented by the operator interface includes a series of questions that ask the operator to identify an anticipated amount of an operating expense during an initial year of operation of the franchise business, to identify an anticipated amount of the operating expense during a first full year of operation of the franchise business, and to identify an anticipated amount of the operating expense during each of a plurality of successive years of operation following the first full year.

17. The financial projections system of claim 16, wherein the question that asks the operator to identify the anticipated amount of the operating expense during each of the plurality of successive years of operation includes a plurality of answers selectable by the operator, the plurality of selectable answers including at least a first answer corresponding to the operating expense changes with changes in sales, and a second answer corresponding to the operating expense increases at a rate of inflation.

18. The financial projections system of claim 17, wherein the plurality of selectable answers includes at least a third answer corresponding to a request by the operator to identify monetary values of the anticipated amount of the operating expense during each of the plurality of successive years of operation.

19. The financial projections system of claim 17, wherein the plurality of selectable answers includes another answer corresponding to no change in an amount of the operating expense during each of the plurality of successive years of operation.

20. The financial projections system of claim 1, wherein the income statement generator controls the operator interface to display to the operator, along with each of the questions that are presented by the operator interface, information that explains to the operator a reason why the respective question is being asked or how an answer to the respective question will be utilized.

21. The financial projections system of claim 1, wherein the income statement generator generates the income statement by including within each field corresponding to a respective financial term, located in a first section corresponding to an initial year of operation of the franchise business, a first amount supplied by the operator in response to a question pertaining to the respective financial term, and by including within each of the fields, located in a second section corresponding to a first full year of operation of the franchise business, a second amount supplied by the operator in response to the respective question pertaining to the respective financial term.

22. The financial projections system of claim 21, wherein the income statement generator further generates the income statement by including within each of the fields, located in a third section corresponding to a plurality of successive years of operation of the franchise business following the first full year, a plurality of amounts corresponding to answers supplied by the operator in response to the respective question pertaining to the respective financial term.

23. The financial projections system of claim 22, wherein the income statement generator generates, for select fields located in the third section, the plurality of amounts as a function of a value of the first amount for the respective field and a type of answer provided by the operator in response to the respective question corresponding to the respective field, the type of answer being selected from a list including at least one of a first answer corresponding to a change with changes in sales of the franchise business, and a second answer corresponding to increases at a rate of inflation.

24. The financial projections system of claim 1, wherein the income statement generator analyzes the operator answers to the presented questions to identify any year-to-year fluctuation for a specific sale or expense that is outside a predetermined range; controls the operator interface to present a question that asks the operator to explain why the operator anticipates said year-to-year fluctuation for said specific sale or expense; and produces a table including an answer received from the operator to each of the questions presented that pertain to identifying any year-to-year fluctuations.

25. The financial projections system of claim 24, wherein the income statement generator transmits the generated income statement and the produced table to a potential investor of the franchise business.

26. The financial projections system of claim 1, wherein the income statement generator controls the operator interface to request the operator to identify an identity of a franchiser of the franchise business, and identifies a type of business of the franchise business based on the identified identity of the franchisor, and the plurality of questions presented by the operator interface is a function of the identified type of business of the franchise business.

27. The financial projections system of claim 1, wherein the income statement generator controls the operator interface to request the operator to identify a type of business of the franchise business, and the plurality of questions presented by the operator interface is a function of the identified type of business of the franchise business.

28. A method of generating an income statement, comprising the steps of:
controlling an operator interface to present to an operator of a franchise business a plurality of questions related to an anticipated performance of the franchise business over a plurality of years;
receiving from the operator via the operator interface answers to each of the presented questions; and
generating an income statement containing financial terms corresponding to the received answers to the presented questions.

29. The method of claim 28, wherein the plurality of questions presented by the operator interface includes a series of questions that ask the operator to identify an anticipated amount of sales during an initial year of operation of the franchise business, to identify an anticipated amount of sales during a first full year of operation of the franchise business, and to identify an anticipated amount of sales during each of a plurality of successive years of operation following the first full year.

30. The method of claim 29, wherein the controlling step comprises controlling the operator interface to request the operator to identify a preferred time period basis in which to provide answers to questions relating to anticipated amounts of sales, the preferred time period basis being one of an annual basis and a non-annual basis; and the generating step comprises converting into yearly amounts values provided by the operator relating to anticipated amounts of sales if the operator identified a preferred time period basis corresponding to a non-annual basis.

31. The method of claim 29, wherein the controlling step comprises controlling the operator interface to request the operator to identify whether the franchise business will generate food sales, non-food sales, or both food and non-food sales; and the series of questions relating to anticipated amounts of sales relates to the type of sales to be generated by the franchise business as identified by the operator; the series of questions relating to anticipated amounts of sales including, if the operator identified both food and non-food sales, a first set of questions relating to anticipated amounts of food sales and a separate, second set of questions relating to anticipated amounts of non-food sales.

32. The method of claim 29, wherein the controlling step comprises controlling the operator interface to display to the operator, along with the question that asks the operator to identify an anticipated amount of sales during each of the plurality of successive years of operation, a plurality of graphical bars that represent the anticipated amount of sales during the successive years of operation, and controlling the operator interface to enable modification of a height of any one or more of the displayed graphical bars, the height of each of the graphical bars representing a value of the anticipated amount of sales during a respective one of the successive years of operation.

33. The method of claim 28, wherein the plurality of questions presented by the operator interface includes a series of questions that ask the operator to identify an anticipated amount of cost of goods sold during an initial year of operation of the franchise business, to identify an anticipated amount of cost of goods sold during a first full year of operation of the franchise business, and to identify an anticipated amount of cost of goods sold during each of a plurality of successive years of operation following the first full year.

34. The method of claim 28, wherein the plurality of questions presented by the operator interface includes a series of questions that ask the operator to identify an anticipated amount of employee compensation during an initial year of operation of the franchise business, to identify an anticipated amount of employee compensation during a first full year of operation of the franchise business, and to identify an anticipated amount of employee compensation during each of a plurality of successive years of operation following the first full year.

35. The method of claim 34, wherein the question that asks the operator to identify the anticipated amount of employee compensation during each of the plurality of successive years of operation includes a plurality of answers selectable by the operator, the plurality of selectable answers including at least a first answer corresponding to the employee compensation changes with changes in sales of the franchise business, and a second answer corresponding to the employee compensation increases at a rate of inflation.

36. The method of claim 35, wherein the plurality of selectable answers includes at least a third answer corresponding to a request by the operator to identify monetary values of the anticipated amount of the employee compensation during each of the plurality of successive years of operation.

37. The method of claim 34, wherein the series of questions includes a first series of questions relating to anticipated amounts of compensation of salaried employees during multiple years of operation of the business and a second series of questions relating to anticipated amounts of compensation of hourly employees during said multiple years of operation.

38. The method of claim 37, wherein the first series of questions request answers in terms of dollar amounts and the second series of questions request answers in terms of percentage of net food sales.

39. The method of claim 28, wherein the plurality of questions presented by the operator interface includes a series of questions that ask the operator to identify an anticipated amount of occupancy costs during an initial year of operation of the franchise business, to identify an anticipated amount of the occupancy costs during a first full year of operation of the franchise business, and to identify an anticipated amount of the occupancy costs during each of a plurality of successive years of operation following the first full year.

40. The method of claim 39, wherein the question that asks the operator to identify the anticipated amount of the occupancy costs during each of the plurality of successive years of operation includes a plurality of answers selectable by the operator, the plurality of selectable answers including at least a first answer corresponding to the operating expense increases at a rate of inflation, and a second answer corresponding to no change in an amount of the occupancy costs during each of the plurality of successive years of operation.

41. The method of claim 28, wherein the plurality of questions presented by the operator interface includes a series of questions relating to franchise royalties to be paid to a franchiser of the franchise business.

42. The method of claim 41, wherein the series of questions includes a first question that asks the operator to indicate whether the franchise royalties are based only on net food sales or are based on net total sales, and a second question that asks the operator to identify a royalty rate as a percent of sales that must be paid to the franchisor.

43. The method of claim 28, wherein the plurality of questions presented by the operator interface includes a series of questions that ask the operator to identify an anticipated amount of an operating expense during an initial year of operation of the franchise business, to identify an anticipated amount of the operating expense during a first full year of operation of the franchise business, and to identify an anticipated amount of the operating expense during each of a plurality of successive years of operation following the first full year.

44. The method of claim 43, wherein the question that asks the operator to identify the anticipated amount of the operating expense during each of the plurality of successive years of operation includes a plurality of answers selectable by the operator, the plurality of selectable answers including at least a first answer corresponding to the operating expense changes with changes in sales, and a second answer corresponding to the operating expense increases at a rate of inflation.

45. The method of claim 44, wherein the plurality of selectable answers includes at least a third answer corresponding to a request by the operator to identify monetary values of the anticipated amount of the operating expense during each of the plurality of successive years of operation.

46. The method of claim 44, wherein the plurality of selectable answers includes another answer corresponding to no change in an amount of the operating expense during each of the plurality of successive years of operation.

47. The method of claim 28, wherein the controlling step comprises controlling the operator interface to display to the operator, along with each of the questions that are presented by the operator interface, information that explains to the operator a reason why the respective question is being asked or how an answer to the respective question will be utilized.

48. The method of claim 28, wherein the generating step comprises generating the income statement by including within each field corresponding to a respective financial term, located in a first section corresponding to an initial year of operation of the franchise business, a first amount supplied by the operator in response to a question pertaining to the respective financial term, and by including within each of the fields, located in a second section corresponding to a first full year of operation of the franchise business, a second amount supplied by the operator in response to the respective question pertaining to the respective financial term.

49. The method of claim 48, wherein the generating step further comprises including within each of the fields, located in a third section corresponding to a plurality of successive years of operation of the franchise business following the first full year, a plurality of amounts corresponding to answers supplied by the operator in response to the respective question pertaining to the respective financial term.

50. The method of claim 49, wherein the generating step comprises generating, for select fields located in the third section, the plurality of amounts as a function of a value of the first amount for the respective field and a type of answer provided by the operator in response to the respective question corresponding to the respective field, the type of answer being selected from a list including at least one of a first answer corresponding to a change with changes in sales of the franchise business, and a second answer corresponding to increases at a rate of inflation.

51. The method of claim 28, further comprising analyzing the operator answers to the presented questions to identify any year-to-year fluctuation for a specific sale or expense that is outside a predetermined range; controlling the operator interface to present a question that asks the operator to explain why the operator anticipates the year-to-year fluctuation for the specific sale or expense; and producing a table including an answer received from the operator to each of the questions presented that pertain to identifying any year-to-year fluctuations.

52. The method of claim 51, further comprising transmitting the generated income statement and the produced table to a potential investor of the franchise business.

53. The method of claim 28, further comprising controlling the operator interface to request the operator to identify an identity of a franchisor of the franchise business; and identifying a type of business of the franchise business based on the identified identity of the franchisor, and the plurality of questions presented by the operator interface is a function of the identified type of business of the franchise business.

54. The method of claim 28, further comprising controlling the operator interface to request the operator to identify a type of business of the franchise business, and the plurality of questions presented by the operator interface is a function of the identified type of business of the franchise business.
